(19) United States
(12) Patent Application Publication
(10) Pub. No.: US 2025/0167908 A1
(43) Pub. Date: May 22, 2025

(54) OPTICAL COMMUNICATION SYSTEM, MASTER STATION DEVICE, SLAVE STATION DEVICE, AND OPTICAL COMMUNICATION METHOD

(71) Applicant: Sumitomo Electric Industries, Ltd., Osaka-shi, Osaka (JP)

(72) Inventors: Yusuke MIYAZEKI, Osaka-shi, Osaka (JP); Tomoyuki FUNADA, Osaka-shi, Osaka (JP); Keisuke JINEN, Osaka-shi, Osaka (JP); Isao KATSURA, Osaka-shi, Osaka (JP); Daisuke KAWASE, Osaka-shi, Osaka (JP); Naruto TANAKA, Osaka-shi, Osaka (JP)

(73) Assignee: Sumitomo Electric Industries, Ltd., Osaka-shi, Osaka (JP)

(21) Appl. No.: 18/838,239

(22) PCT Filed: Feb. 21, 2023
(86) PCT No.: PCT/JP2023/006099

§ 371 Date: Aug. 14, 2024

(30) Foreign Application Priority Data
Mar. 1, 2022 (JP) 2022-030708

(51) Int. Cl. H04J 14/02; H04B 10/25

(52) U.S. Cl. CPC H04J 14/02; H04B 10/25

(57) ABSTRACT

An optical communication system includes: a master station device and a slave station device. The master station device generates a digital signal including one frame in which plural pieces of control information are stored, and transmits an optical signal including the generated digital signal and an analog main signal, to the slave station device via an optical fiber. The slave station device acquires at least one piece of control information out of the plural pieces of control information, from the digital signal included in the optical signal received from the master station device via the optical fiber.

### TECHNICAL FIELD

The present disclosure relates to an optical communication system, a master station device, a slave station device, and an optical communication method.

This application claims priority on Japanese Patent Application No. 2022-30708 filed on Mar. 1, 2022, the entire content of which is incorporated herein by reference.

### BACKGROUND ART

PATENT LITERATURE 1 (Japanese Laid-Open Patent Publication No. 2021-64861) discloses an optical transmission device as follows. That is, the optical transmission device includes: multiplexing means for generating a multiplex signal by frequency-multiplexing a first electric signal that carries information with a plurality of tone signals to generate a multiplex signal; and modulation means for performing carrier suppression amplitude modulation of continuous light with the multiplex signal.

Meanwhile, PATENT LITERATURE 2 (Japanese Laid-Open Patent Publication No. 2020-43488) discloses an amplifier unit as follows. That is, the amplifier unit includes: a digital signal generator that generates a digital signal of a modulation frequency fm, and outputs the digital signal; an analog signal generator that generates an analog signal of a frequency fc, having information in an amplitude, and outputs the analog signal; a superimposition section that generates a superimposed signal by superimposing the digital signal on the analog signal, and outputs the superimposed signal; an amplifier that generates an amplified signal by amplifying the superimposed signal, and outputs the amplified signal; a detector that detects information on voltage of the amplified signal; and an amplification degree determination section that determines an amplification degree of the amplifier, based on the information detected by the detector. A relationship between an input voltage of an input signal inputted to the amplifier and an output voltage of an output signal outputted from the amplifier has a region where an amplification degree changes so that the output voltage becomes a predetermined constant value from a region where the output voltage increases as the input voltage increases. The input voltage of the digital signal inputted to the amplifier is a voltage at which the output voltage of the digital signal amplified with the amplification degree becomes the constant value. In addition, the input voltage of the analog signal inputted to the amplifier is a voltage at which the output voltage of the analog signal amplified with the amplification degree becomes a value proportional to the amplification degree.

### CITATION LIST

### Patent Literature

PATENT LITERATURE 1: Japanese Laid-Open Patent Publication No. 2021-64861

PATENT LITERATURE 2: Japanese Laid-Open Patent Publication No. 2020-43488

### SUMMARY OF THE INVENTION

### Technical Problem

An optical communication system of the present disclosure includes a master station device and a slave station device. The master station device generates a digital signal including one frame in which plural pieces of control information are stored, and transmits an optical signal including the generated digital signal and an analog main signal, to the slave station device via an optical fiber. The slave station device acquires at least one piece of control information out of the plural pieces of control information, from the digital signal included in the optical signal received from the master station device via the optical fiber.

A master station device of the present disclosure includes: a generation unit configured to generate a digital signal including one frame in which plural pieces of control information are stored; and a transmission unit configured to transmit an optical signal including the digital signal generated by the generation unit, and an analog main signal, to another device via an optical fiber.

A slave station device of the present disclosure includes: a reception unit configured to receive an optical signal that includes a digital signal including one frame in which plural pieces of control information are stored, and an analog main signal, from another device via an optical fiber; and an acquisition unit configured to acquire at least one control information out of the plural pieces of control information, from the digital signal included in the optical signal received by the reception unit.

An optical communication method of the present disclosure is an optical communication method in an optical communication system including a master station device and a slave station device. The method includes: by the master station device, generating a digital signal including one frame in which plural pieces of control information are stored, and transmitting an optical signal including the generated digital signal and an analog main signal, to the slave station device via an optical fiber; and, by the slave station device, acquiring at least one piece of control information out of the plural pieces of control information, from the digital signal included in the optical signal received from the master station device via the optical fiber.

One mode of the present disclosure can be realized not only as a master station device including such a characteristic processing unit but also as an optical communication method including such characteristic process steps as well as a program for causing a computer to execute such process steps. Moreover, one mode of the present disclosure can be realized as a semiconductor integrated circuit that realizes a part or the entirety of the master station device.

One mode of the present disclosure can be realized not only as a slave station device including such a characteristic processing unit but also as an optical communication method including such characteristic process steps as well as a program for causing a computer to execute such process steps. Moreover, one mode of the present disclosure can be realized as a semiconductor integrated circuit that realizes a part or the entirety of the slave station device.

### BRIEF DESCRIPTION OF DRAWINGS

FIG. 1 shows a configuration of an optical communication system according to a first embodiment of the present disclosure.

FIG. 2 shows a configuration of a master station device according to the first embodiment of the present disclosure.

FIG. 3 schematically shows an example of a frequency spectrum of an electric signal generated by a multiplexer in the master station device according to the first embodiment of the present disclosure.

FIG. 4 shows a configuration of a slave station device according to the first embodiment of the present disclosure.

FIG. 5 shows an example of a sequence of communication in the optical communication system according to the first embodiment of the present disclosure.

FIG. 6 shows a configuration of an optical communication system according to a second embodiment of the present disclosure.

FIG. 7 shows a configuration of a master station device according to the second embodiment of the present disclosure.

FIG. 8 schematically shows an example of a frequency spectrum of an optical signal outputted by a multiplexer in the master station device according to the second embodiment of the present disclosure.

FIG. 9 shows a configuration of a slave station device according to the second embodiment of the present disclosure.

### DETAILED DESCRIPTION

Conventionally, for an optical communication system in which an analog signal including communication data is transmitted between devices via an optical fiber, a technology of multiplexing control information for controlling the operation of one of the devices on the analog signal to transmit the control information, has been developed.

### Problems to be Solved by the Present Disclosure

Beyond the technologies described in PATENT LITERATURES 1 and 2, there is a demand for a technology that can transmit control information more efficiently with a simple configuration.

The present disclosure is made to solve the above problem, and an object of the present disclosure is to provide an optical communication system, a master station device, a slave station device, and an optical communication method capable of transmitting control information more efficiently with a simple configuration.

### Effect of the Present Disclosure

According to the present disclosure, control information can be transmitted more efficiently with a simple configuration.

### DESCRIPTION OF EMBODIMENTS OF THE PRESENT DISCLOSURE

First, contents of the embodiments of the present disclosure are listed and described.

(1) An optical communication system according to an embodiment of the present disclosure includes a master station device and a slave station device. The master station device generates a digital signal including one frame in which plural pieces of control information are stored, and transmits an optical signal including the generated digital signal and an analog main signal, to the slave station device via an optical fiber. The slave station device acquires at least one piece of control information out of the plural pieces of control information, from the digital signal included in the optical signal received from the master station device via the optical fiber.

In the above configuration, the optical signal that includes a digital signal including one frame in which plural pieces of control information are stored, and the main signal is transmitted via the optical fiber. Therefore, the plural pieces of control information can be collectively transmitted without the necessity of strictly controlling the frequency of the main signal. As a result, the control information can be efficiently transmitted with a simple configuration.

(2) In the above (1), the master station device may generate the optical signal based on an electric signal in which the digital signal and the main signal are frequency-multiplexed, and transmit the generated optical signal to the slave station device via the optical fiber.

In the above configuration, it is possible to transmit each signal with high frequency utilization efficiency by using the optical signal of a single wavelength including the digital signal and the main signal, as compared to the configuration in which the digital signal and the main signal are wavelength-multiplexed.

(3) In the above (2), the master station device may frequency-multiplex a signal passing through a first low-pass filter that receives the digital signal, with the main signal.

In the above configuration, in the master station device, noise originating from the digital signal can be reduced, and reduction in transmission quality of the main signal can be inhibited.

(4) In the above (2) or (3), the slave station device may generate an electric signal based on the optical signal received from the master station device via the optical fiber, separate the digital signal from the electric signal by using a filter, and acquire the control information from a signal passing through a second low-pass filter that receives the separated digital signal.

In the above configuration, in the slave station device, noise originating from the digital signal can be reduced, and reduction in transmission quality of the main signal can be inhibited.

(5) In the above (1), the master station device may generate a first optical signal based on the digital signal, generate the optical signal by wavelength-multiplexing the generated first optical signal with a second optical signal based on the main signal, and transmit the generated optical signal to the slave station device via the optical fiber.

In the above configuration, influence of the digital signal on the main signal can be reduced, and the transmission quality of the main signal can be improved, as compared to the configuration in which the digital signal and the main signal are frequency-multiplexed.

(6) A master station device according to the embodiment of the present disclosure includes: a generation unit configured to generate a digital signal including one frame in which plural pieces of control information are stored; and a transmission unit configured to transmit an optical signal including the digital signal generated by the generation unit, and an analog main signal, to another device via an optical fiber.

In the above configuration, the optical signal that includes a digital signal including one frame in which plural pieces of control information are stored, and the main signal is transmitted via the optical fiber. Therefore, the plural pieces of control information can be collectively transmitted without the necessity of strictly controlling the frequency of the main signal. As a result, the control information can be efficiently transmitted with a simple configuration.

(7) A slave station device according to the embodiment of the present disclosure includes: a reception unit configured to receive an optical signal that includes a digital signal including one frame in which plural pieces of control information are stored, and an analog main signal, from another device via an optical fiber; and an acquisition unit configured to acquire at least one control information out of the plural pieces of control information, from the digital signal included in the optical signal received by the reception unit.

In the above configuration, the optical signal that includes a digital signal including one frame in which plural pieces of control information are stored, and the main signal is received, and the control information is acquired from the digital signal included in the received optical signal. Therefore, the plural pieces of control information can be collectively transmitted without the necessity of strictly controlling the frequency of the main signal. As a result, the control information can be efficiently transmitted with a simple configuration.

(8) An optical communication method according to the embodiment of the present disclosure is an optical communication method in an optical communication system including a master station device and a slave station device. The method includes: by the master station device, generating a digital signal including one frame in which plural pieces of control information are stored, and transmitting an optical signal including the generated digital signal and an analog main signal, to the slave station device via an optical fiber; and, by the slave station device, acquiring at least one piece of control information out of the plural pieces of control information, from the digital signal included in the optical signal received from the master station device via the optical fiber.

In the above method, the optical signal that includes a digital signal including one frame in which plural pieces of control information are stored, and the main signal is transmitted via the optical fiber. Therefore, the plural pieces of control information can be collectively transmitted without the necessity of strictly controlling the frequency of the main signal. As a result, the control information can be efficiently transmitted with a simple configuration.

Hereinafter, embodiments of the present disclosure will be described with reference to the drawings. In the drawings, the same or corresponding parts are denoted by the same reference signs, and description thereof is not repeated. At least some parts of the embodiments described below may be combined together as desired.

### First Embodiment

### [Configuration and Basic Operation]

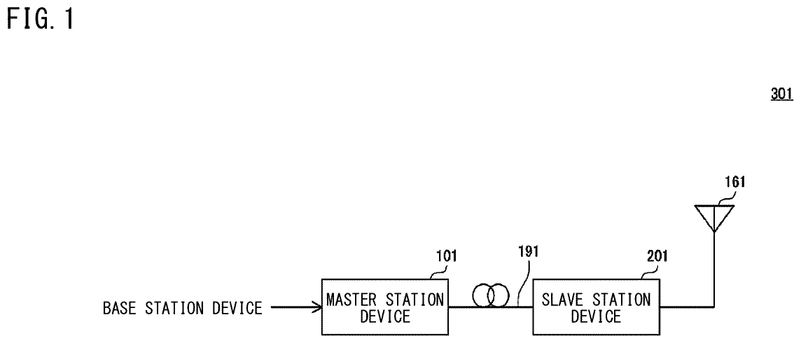

FIG. 1 shows a configuration of an optical communication system according to the first embodiment of the present disclosure. With reference to FIG. 1, an optical communication system 301 includes a master station device 101 and a slave station device 201. The master station device 101 and the slave station device 201 are connected to each other via an optical fiber 191. The optical communication system 301 may be configured to include a plurality of slave station devices 201. In this case, for example, the plurality of slave station devices 201 are connected to the master station device 101 via an optical fiber 191 and an optical coupler. For example, the optical communication system 301 is an analog RoF (Radio over Fiber) system.

For example, the master station device 101 and slave station device 201 transmit and receive communication data via the optical fiber 191.

More specifically, the master station device 101 receives an OFDM (Orthogonal Frequency Division Multiplexing) modulated analog signal including communication data from a base station device (not shown). The master station device 101 frequency-converts the received analog signal to generate an IF (Intermediate Frequency) signal. The IF signal is an example of a main signal. The master station device 101 transmits an optical signal including the generated IF signal to the slave station device 201 via the optical fiber 191.

The slave station device 201 receives the optical signal from the master station device 101 via the optical fiber 191. The slave station device 201 acquires the IF signal from the received optical signal, and transmits an RF (Radio Frequency) signal based on the acquired IF signal via an antenna 161. The slave station device 201 may be configured to transmit the signal based on the acquired IF signal to another device via wires.

The slave station device 201 receives a millimeter-wave-band RF signal that includes communication data and is OFDM-modulated, from a mobile communication terminal (not shown) via the antenna 161. The slave station device 201 frequency-converts the received RF signal to generate an IF signal, and transmits an optical signal including the generated IF signal to the master station device 101 via the optical fiber 191. The slave station device 201 may be configured to receive the signal including the communication data via wires, and transmit an optical signal including the received signal to the master station device 101 via the optical fiber 191.

The master station device 101 receives the optical signal from the slave station device 201 via the optical fiber 191. The master station device 101 acquires the IF signal from the received optical signal, and transmits a signal based on the acquired IF signal to the base station device.

Furthermore, the master station device 101 periodically or non-periodically transmits plural pieces of control information to the slave station device 201. More specifically, the master station device 101 generates a digital signal including one frame in which the plural pieces of control information are stored.

The master station device 101 transmits an optical signal including the generated digital signal and the IF signal to the slave station device 201 via the optical fiber 191. More specifically, the master station device 101 generates an optical signal based on an electric signal in which the digital signal and the IF signal are frequency-multiplexed, and transmits the generated optical signal to the slave station device 201 via the optical fiber 191.

The slave station device 201 acquires the frame from the digital signal included in the optical signal received from the master station device 101 via the optical fiber 191, and acquires the plural pieces of control information from the acquired frame. The slave station device 201 operates according to the acquired plural pieces of control information.

### (Master Station Device)

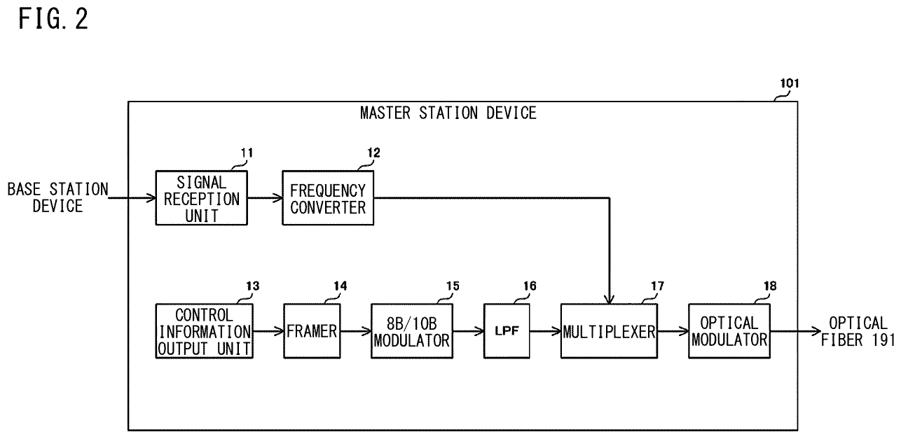

FIG. 2 shows a configuration of a master station device according to the first embodiment of the present disclosure. With reference to FIG. 2, the master station device 101 includes a signal reception unit 11, a frequency converter 12, a control information output unit 13, a framer 14, an 8B/10B modulator 15, an LPF (Low Pass Filter) 16, a multiplexer 17, and an optical modulator 18. The framer 14 is an example of a generation unit. The optical modulator 18 is an example of a transmission unit. The LPF 16 is an example of a first low-pass filter. Some or all of the signal reception unit 11, the frequency converter 12, the control information output unit 13, the framer 14, and the 8B/10B modulator 15 are realized by, for example, processing circuitry including one or a plurality of processors.

The signal reception unit 11 receives, from the base station device (not shown), an OFDM-modulated analog signal including communication data. The signal reception unit 11 may be configured to receive an RF signal or a baseband signal as the analog signal. The signal reception unit 11 outputs the received analog signal to the frequency converter 12.

The frequency converter 12 up-converts or down-converts the analog signal received from the signal reception unit 11 to generate an IF signal having a center frequency fa, and outputs the generated IF signal to the multiplexer 17.

The control information output unit 13 generates control information for controlling the slave station device 201. For example, the control information output unit 13 generates plural kinds of control information. More specifically, the control information output unit 13 generates, as control information, beamforming information for controlling an RF signal transmission direction, synchronization information for controlling RF signal transmission timing according to TDD (Time Division Duplex), register control information for controlling registers of an FPGA (Field-Programmable Gate Array) in the slave station device 201, and the like. The control information output unit 13 outputs the generated control information to the framer 14. The control information output unit 13 may be configured to output control information acquired from the base station device (not shown) to the framer 14, instead of or in addition to outputting the generated control information to the framer 14.

The framer 14 generates a digital signal including one frame in which plural pieces of control information are stored. As an example, the framer 14 periodically or non-periodically generates an Ethernet (registered trademark) frame which is addressed to the slave station device 201 and in which the plural pieces of control information received from the control information output unit 13 are stored in the payload. For example, the framer 14 generates an Ethernet frame which includes a MAC address of the slave station device 201 as a destination MAC address and in which plural kinds of control information are stored in the payload. The framer 14 may be configured to generate an Ethernet frame in which plural pieces of control information of a single kind are stored in the payload. The framer 14 outputs a binary digital signal including the generated Ethernet frame to the 8B/10B modulator 15.

The framer 14 may store the control information in a plurality of fields in the Ethernet frame. This enables the control information, for which frequent update is desired, to be quickly transmitted to the slave station device 201.

The 8B/10B modulator 15 8B/10B-modulates the digital signal received from the framer, and outputs the resultant signal to the LPF 16. That is, the 8B/10B modulator 15 converts an 8-bit digital signal received from the framer into a 10-bit digital signal, and outputs the resultant signal to the LPF 16.

The LPF 16 receives the digital signal from the 8B/10B modulator 15, and attenuates frequency components equal to or higher than a predetermined frequency in the received digital signal. For example, the LPF 16 is a Bessel filter which has a filter order of 4 or more, and attenuates frequency components equal to or higher than a cutoff frequency fc. The cutoff frequency fc is lower than the center frequency fa of the IF signal generated by the frequency converter 12. The LPF 16 outputs, to the multiplexer 17, the digital signal in which the frequency components equal to or higher than the cutoff frequency fc have been attenuated.

For example, the multiplexer 17 frequency-multiplexes the signal having passed through the LPF 16, with the IF signal. More specifically, the multiplexer 17 frequency-multiplexes the digital signal received from the LPF 16, with the IF signal received from the frequency converter 12. The multiplexer 17 generates an electric signal M1 in which the digital signal and the IF signal are frequency-multiplexed, and outputs the electric signal M1 to the optical modulator 18.

The master station device 101 may be configured to receive an IF signal from the base station device, and transmit an optical signal including the received IF signal to the slave station device 201 via the optical fiber 191. More specifically, the master station device 101 may not necessarily include the frequency converter 12. In this case, the signal reception unit 11 receives the IF signal from the base station device, and outputs the received IF signal to the multiplexer 17. The multiplexer 17 receives the IF signal from the signal reception unit 11, and frequency-multiplexes the digital signal received from the LPF 16, with the IF signal received from the signal reception unit 11.

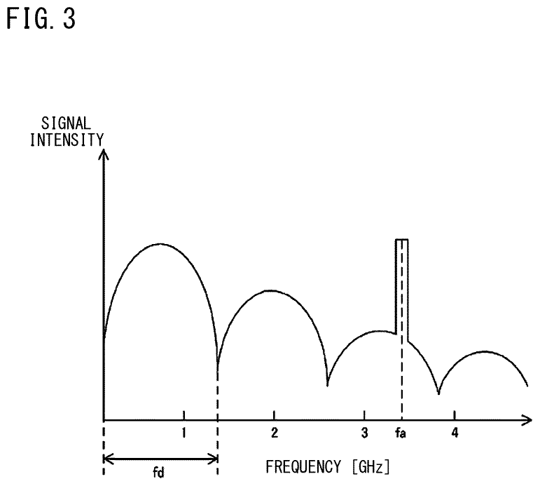

FIG. 3 schematically shows an example of a frequency spectrum of an electric signal generated by a multiplexer in the master station device according to the first embodiment of the present disclosure. In FIG. 3, the horizontal axis represents frequency [GHz], and the vertical axis represents signal intensity.

With reference to FIG. 3, the frequency converter 12 generates an IF signal having a center frequency fa in a frequency domain other than a frequency domain in which the intensity of harmonics of the digital signal generated by the framer 14 drops, and outputs the IF signal to the multiplexer 17. More specifically, the frequency converter 12 generates an IF signal having a center frequency fa that satisfies the following formula (1), and outputs the IF signal to the multiplexer 17.

$$n \times fd + k \times fd < fa < ( n + 1 ) \times fd - k \times fd \qquad ( 1 )$$

In formula (1), n is an integer not less than 1, k is a value larger than zero and smaller than 0.1, and fd is a band width of control information. Since the frequency converter 12 is configured to generate the IF signal having the center frequency fa that satisfies the above formula (1), it is possible to inhibit reduction in transmission quality of the IF signal due to influence of DC component noise that occurs when the duty ratio of the digital signal generated by the framer 14 is not 50%.

The optical modulator 18 transmits an optical signal including the digital signal generated by the framer 14 and the IF main signal, to the slave station device 201 via the optical fiber 191. More specifically, the optical modulator 18 receives the electric signal M1 from the multiplexer 17, generates an optical signal by optically modulating the received electric signal M1, and outputs the generated optical signal to the optical fiber 191.

### (Slave Station Device)

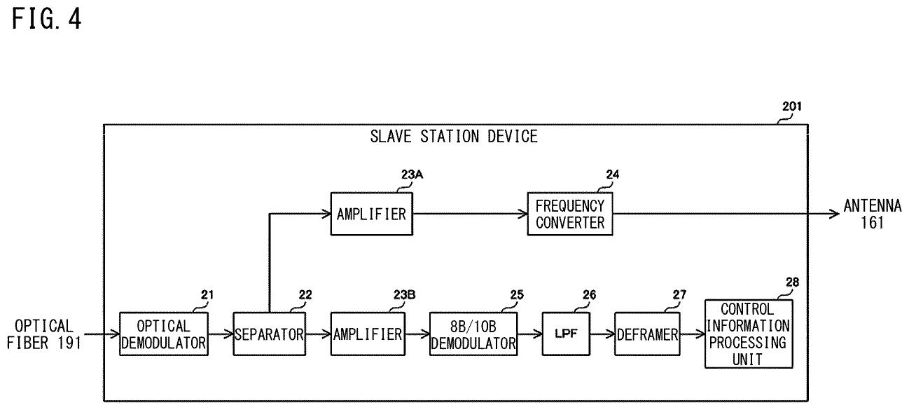

FIG. 4 shows a configuration of a slave station device according to the first embodiment of the present disclosure. With reference to FIG. 4, the slave station device 201 includes an optical demodulator 21, a separator 22, amplifiers 23A, 23B, a frequency converter 24, an 8B/10B demodulator 25, an LPF 26, a deframer 27, and a control information processing unit 28. The optical demodulator 21 is an example of a reception unit. The deframer 27 is an example of an acquisition unit. The LPF 26 is an example of a second low-pass filter. Some or all of the frequency converter 24, the 8B/10B demodulator 25, the deframer 27, and the control information processing unit 28 are realized by, for example, processing circuitry including one or a plurality of processors.

The optical demodulator 21 receives, from the master station device 101 via the optical fiber 191, an optical signal that includes a digital signal including one Ethernet frame in which plural pieces of control information are stored, and an IF signal, and generates an electric signal M2 based on the received optical signal. More specifically, the optical demodulator 21 generates an electric signal M2 having a level corresponding to the intensity of the received optical signal, and outputs the electric signal M2 to the separator 22.

The separator 22 receives the electric signal M2 from the optical demodulator 21, and separates the digital signal including the Ethernet frame from the received electric signal M2. More specifically, the separator 22 outputs some of the frequency components of the electric signal M2 to the amplifier 23A, and outputs the remaining frequency components to the amplifier 23B.

For example, the separator 22 is a diplexer composed of an HPF (High Pass Filter) and an LPF. The separator 22 outputs an electric signal M2a, of the electric signal M2, corresponding to frequency components equal to or higher than a frequency Fx to the amplifier 23A, and outputs an electric signal M2b, of the electric signal M2, corresponding to frequency components lower than the frequency Fx to the amplifier 23B. Here, the frequency Fx is lower than the center frequency fa of the IF signal. The electric signal M2a includes the IF signal generated by the frequency converter 12 in the master station device 101. The electric signal M2b includes the digital signal having passed through the LPF 16 in the master station device 101.

The amplifier 23A receives the electric signal M2a from the separator 22, and amplifies the received electric signal M2a. For example, the amplifier 23A is a linear amplifier. The amplifier 23A outputs the amplified electric signal M2a to the frequency converter 24.

The amplifier 23B receives the electric signal M2b from the separator 22, and amplifies the received electric signal M2b. For example, the amplifier 23B is a limiting amplifier. The amplifier 23B outputs the amplified electric signal M2b to the 8B/10B demodulator 25.

As described above, the electric signal M2a and the electric signal M2b are separated from the electric signal M2, and the electric signals M2a, M2b are respectively amplified by using the amplifiers 23A, 23B. In this configuration, a linear amplifier can be used as the amplifier 23A, and a limiting amplifier can be used as the amplifier 23B. This can avoid waveform distortion of the digital signal which may occur when a linear amplifier is used as the amplifier 23B. In addition, as compared with the configuration in which the electric signal M2 is amplified without separating the electric signal M2a and the electric signal M2b, the circuit scale of the slave station device 201 can be further reduced.

For example, the frequency converter 24 up-converts the electric signal M2a received from the amplifier 23A to generate an RF signal, and outputs the generated RF signal to the antenna 161. Alternatively, the frequency converter 24 down-converts the electric signal M2a received from the amplifier 23A to generate a baseband signal, and transmits the generated baseband signal to a device outside the slave station device 201.

The 8B/10B demodulator 25 8B/10B-demodulates the electric signal M2b received from the amplifier 23B, and outputs the resultant signal to the LPF 26. That is, the 8B/10B demodulator 25 converts a 10-bit electric signal M2b received from the amplifier 23B into an 8-bit electric signal M2b, and outputs the resultant signal to the LPF 26.

The LPF 26 receives the electric signal M2b from the 8B/10B demodulator 25, and attenuates components equal to or higher than a predetermined frequency in the received electric signal M2b. For example, the LPF 26 is a Bessel filter which has a filter order of 4 or more and attenuates frequency components equal to or higher than a cutoff frequency fc. The LPF 26 outputs, to the deframer 27, the electric signal M2b in which the components equal to or higher than the cutoff frequency fc have been attenuated.

The deframer 27 acquires the plural pieces of control information from the digital signal included in the optical signal received by the optical demodulator 21. For example, the deframer 27 acquires the control information from the signal having passed through the LPF 26.

More specifically, the deframer 27 receives the electric signal M2b from the LPF 26, and acquires the Ethernet frame from the received electric signal M2b. If the destination MAC address included in the acquired Ethernet frame does not match the MAC address of the slave station device 201, the deframer 27 discards the Ethernet frame. Meanwhile, if the destination MAC address included in the acquired Ethernet frame matches the MAC address of the slave station device 201, the deframer 27 acquires the plural pieces of control information from the payload of the Ethernet frame. The deframer 27 outputs the acquired plural pieces of control information to the control information processing unit 28.

The control information processing unit 28 receives the plural pieces of control information from the deframer 27, and processes the received control information. For example, the control information processing unit 28 receives beamforming information as an example of the control information, and performs a process of controlling the direction of a beam outputted from the antenna 161, according to the received beamforming information.

### [Operation Flow]

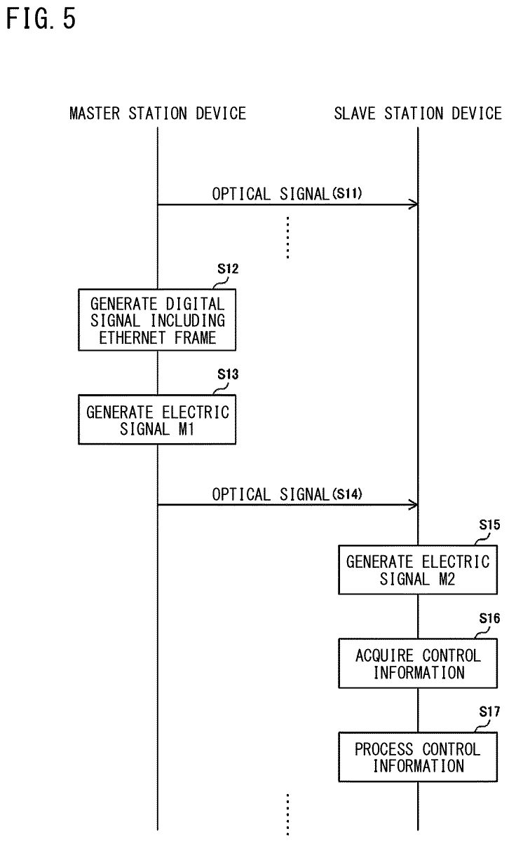

FIG. 5 shows an example of a sequence of communication in the optical communication system according to the first embodiment of the present disclosure.

With reference to FIG. 5, the master station device 101 transmits an optical signal obtained by optically modulating an IF signal, to the slave station device 201 via the optical fiber 191 (step S11).

Next, when there is a need to control the slave station device 201, the master station device 101 generates a digital signal including one Ethernet frame in which plural pieces of control information for controlling the slave station device 201 are stored (step S12).

Next, the master station device 101 generates an electric signal M1 in which the IF signal and the generated digital signal are frequency-multiplexed (step S13).

Next, the master station device 101 transmits an optical signal obtained by optically modulating the electric signal M1 to the slave station device 201 via the optical fiber 191 (step S14).

Next, the slave station device 201 receives the optical signal from the master station device 101 via the optical fiber 191, and generates an electric signal M2 having a level according to the intensity of the received optical signal (step S15).

Next, the slave station device 201 acquires the Ethernet frame from the electric signal M2b, of the electric signal M2, corresponding to the frequency components lower than the frequency Fx, and acquires the plural pieces of control information from the payload of the Ethernet frame (step S16).

Next, the slave station device 201 processes the acquired plural pieces of control information (step S17).

The master station device 101 according to the first embodiment of the present disclosure includes the LPF 16, but the present disclosure is not limited thereto. The master station device 101 may not necessarily include the LPF 16, depending on the transmission quality required for the optical communication system 301, the range of the transmission band, and the like.

The master station device 101 according to the first embodiment of the present disclosure includes one frequency converter 12, but the present disclosure is not limited thereto. The master station device 101 may include a plurality of frequency converters 12 according to the number of antennae 161 placed at different positions. In this case, the multiplexer 17 generates an electric signal in which a plurality of IF signals, which are generated by the respective frequency converters 12 and include communication data corresponding to the respective antennae 161, are frequency-multiplexed with the digital signal, and outputs the electric signal to the optical modulator 18.

The slave station device 201 according to the first embodiment of the present disclosure includes the LPF 26, but the present disclosure is not limited thereto. The slave station device 201 may not necessarily include the LPF 26, depending on the transmission quality required for the optical communication system 301, the range of the transmission band, and the like.

The master station device 101 according to the first embodiment of the present disclosure includes the 8B/10B modulator 15, but the present disclosure is not limited thereto. The master station device 101 may not necessarily include the 8B/10B modulator 15. However, in the configuration in which the master station device 101 includes the 8B/10B modulator 15, the DC component of the digital signal is reduced, and occurrence of baseline wander is inhibited, as compared to the configuration in which the master station device 101 does not include the 8B/10B modulator 15.

In the master station device 101 according to the first embodiment of the present disclosure, the frequency converter 12 generates the IF signal having the center frequency fa that satisfies the above formula (1), but the present disclosure is not limited thereto. The frequency converter 12 may be configured to generate an IF signal having a center frequency fa that does not satisfy the above formula (1). In this case, for example, the master station device 101 further includes a DC (Direct Current) removal unit in a stage following the 8B/10B modulator 15 and preceding the LPF 16. The DC removal unit receives the digital signal from the 8B/10B modulator 15, removes the DC component from the received digital signal, and outputs the digital signal from which the DC component has been removed to the LPF 16.

Meanwhile, a technology capable of transmitting control information more efficiently with a simple configuration is desired.

For example, in the technology disclosed in PATENT LITERATURE 1, the wireless device that receives a multiplex signal in which a plurality of tone signals being sine waves are multiplexed with an IF signal, requires an FFT (Fast Fourier Transform) circuit for separating the tone signals from the received signal and processing the tone signals. Therefore, the circuit configuration of the wireless device may be complicated. In addition, since the frequencies of the tone signals and the IF signal need to be strictly controlled in order to inhibit interference between the tone signals and interference between the tone signals and the IF signal, the configuration of the optical transmission device that transmits the multiplex signal may also be complicated. In addition, in the technology described in PATENT LITERATURE 1, plural kinds of control information cannot be collectively transmitted from the optical transmission device to the wireless device.

Also, the technology disclosed in PATENT LITERATURE 2 cannot collectively transmit plural kinds of control information from the transmission device to the reception device.

In contrast to the conventional technologies, in the optical communication system 301 according to the first embodiment of the present disclosure, the master station device 101 generates a digital signal including one frame in which plural pieces of control information are stored, and transmits an optical signal including the generated digital signal and an IF signal to the slave station device 201 via the optical fiber 191. The slave station device 201 acquires at least one piece of control information among the plural pieces of control information from the digital signal included in the optical signal received from the master station device 101 via the optical fiber 191.

As described above, since the optical signal that includes the digital signal including one frame in which plural pieces of control information are stored, and the IF signal is transmitted via the optical fiber, the plural pieces of control information can be collectively transmitted without the necessity of strictly controlling the frequency of the IF signal. Therefore, the control information can be transmitted more efficiently with a simple configuration. Moreover, various kinds of control information can be flexibly transmitted by changing the frame format.

Next, another embodiment of the present disclosure will be described with reference to the drawings. In the drawings, the same or corresponding parts are denoted by the same reference signs, and description thereof is not repeated.

### Second Embodiment

The present embodiment relates to an optical communication system 302 that transmits a wavelength-multiplexed optical signal via an optical fiber 191, as compared to the optical communication system 301 according to the first embodiment. The optical communication system 302 is identical to the optical communication system 301 of the first embodiment except for the content described below.

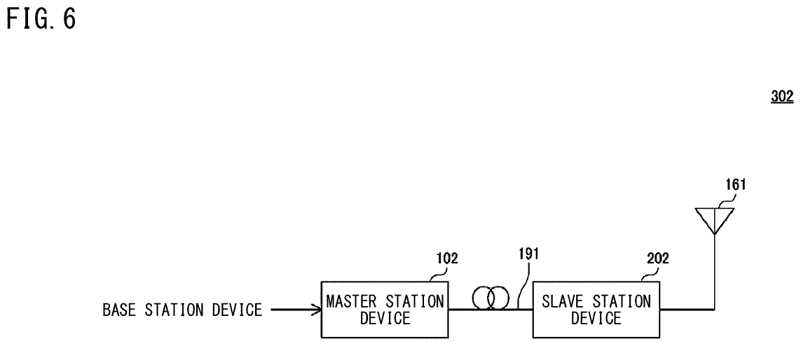

FIG. 6 shows a configuration of an optical communication system according to the second embodiment of the present disclosure. With reference to FIG. 6, the optical communication system 302 includes a master station device 102 instead of the master station device 101, and includes a slave station device 202 instead of the slave station device 201, as compared to the optical communication system 301 shown in FIG. 1.

The master station device 102 transmits an optical signal including a digital signal and an IF signal to the slave station device 202 via the optical fiber 191. More specifically, the master station device 102 generates an optical signal based on a digital signal, wavelength-multiplexes the generated optical signal with an optical signal based on the IF signal, and transmits the resultant signal to the slave station device 202 via the optical fiber 191.

The slave station device 202 acquires control information from the digital signal included in the optical signal received from the master station device 102 via the optical fiber 191. The slave station device 202 operates according to the acquired control information.

### (Master Station Device)

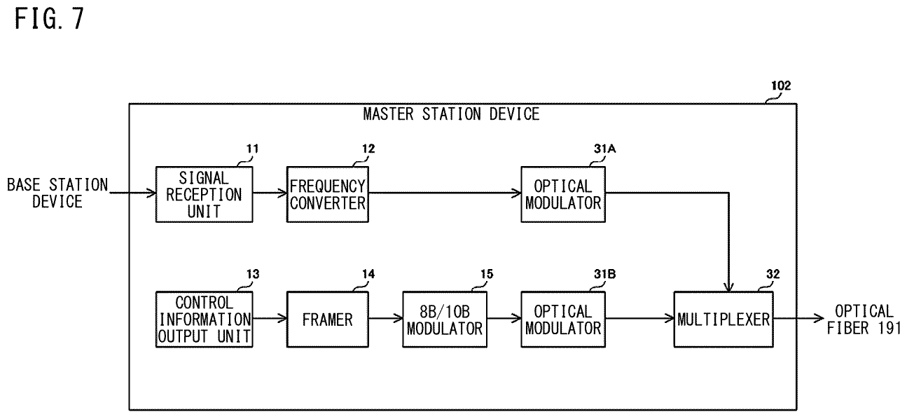

FIG. 7 shows a configuration of a master station device according to the second embodiment of the present disclosure. With reference to FIG. 7, the master station device 102 includes optical modulators 31A, 31B and a multiplexer 32 instead of the LPF 16, the multiplexer 17, and the optical modulator 18, as compared to the master station device 101 shown in FIG. 2. The multiplexer 32 is an example of a transmission unit.

The frequency converter 12 receives an analog signal from the signal reception unit 11, up-converts or down-converts the received analog signal to generate an IF signal, and outputs the generated IF signal to the optical modulator 31A.

The optical modulator 31A receives the IF signal from the frequency converter 12, generates an optical signal of a wavelength λ1 by optically modulating the received IF signal, and outputs the generated optical signal to the multiplexer 32. The optical signal of the wavelength λ1 generated by the optical modulator 31A is an example of a second optical signal.

The 8B/10B modulator 15 receives a digital signal including an Ethernet frame from the framer 14, 8B/10B-modulates the received digital signal, and outputs the resultant signal to the optical modulator 31B.

The optical modulator 31B receives the digital signal from the 8B/10B modulator 15, generates an optical signal of a wavelength 22 by optically modulating the received digital signal, and outputs the generated optical signal to the multiplexer 32. The optical signal of the wavelength 22 generated by the optical modulator 31B is an example of a first optical signal.

The multiplexer 32 wavelength-multiplexes the optical signal of the wavelength λ1 received from the optical modulator 31A, with the optical signal of the wavelength λ2 received from the optical modulator 31B. For example, the multiplexer 32 is an optical coupler. The multiplexer 32 outputs the wavelength-multiplexed optical signal to the optical fiber 191.

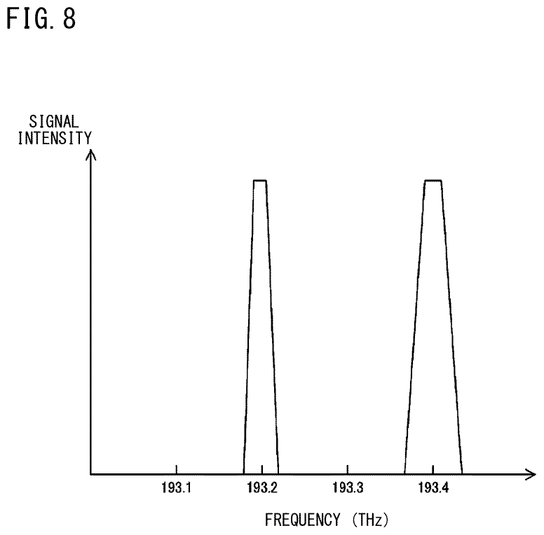

FIG. 8 schematically shows an example of a frequency spectrum of an optical signal outputted by a multiplexer in the master station device according to the second embodiment of the present disclosure. In FIG. 8, the horizontal axis represents frequency [THz], and the vertical axis represents signal intensity.

With reference to FIG. 8, the multiplexer 32 combines the optical signal of the wavelength λ1, having a center frequency of 193.4 THz, with the optical signal of the wavelength λ2, having a center frequency of 193.2 THz, and outputs the resultant signal to the optical fiber 191.

### (Slave Station Device)

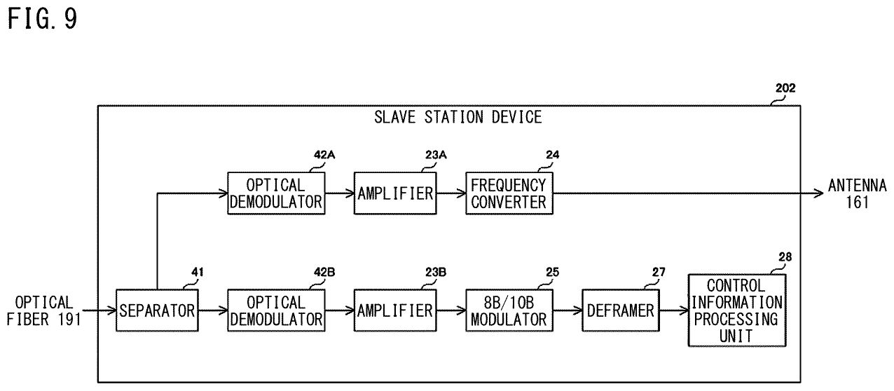

FIG. 9 shows a configuration of a slave station device according to the second embodiment of the present disclosure. With reference to FIG. 9, the slave station device 202 includes a separator 41 and optical demodulators 42A, 42B instead of the optical demodulator 21, the separator 22, and the LPF 26, as compared to the slave station device 201 shown in FIG. 4. The separator 41 is an example of a reception unit.

The separator 41 receives, from the master station device 102 via the optical fiber 191, an optical signal that includes a digital signal including one Ethernet frame in which plural pieces of control information are stored, and an IF signal, and separates the received optical signal according to wavelengths. For example, the separator 41 is an optical coupler. The separator 41 outputs an optical signal of a wavelength λ1 and an optical signal of a wavelength λ2, out of the received optical signal, to the optical demodulator 42A and the optical demodulator 42B, respectively. The optical signal of the wavelength λ1 includes the IF signal generated by the frequency converter 12 in the master station device 102. The optical signal of the wavelength λ2 includes the digital signal modulated by the 8B/10B modulator 15 in the master station device 102.

The optical demodulator 42A receives the optical signal of the wavelength λ1 from the separator 41, generates an electric signal M2a having a level according to the intensity of the optical signal, and outputs the electric signal M2a to the amplifier 23A.

The amplifier 23A receives the electric signal M2a from the separator 41, amplifies the received electric signal M2a, and outputs the amplified electric signal M2a to the frequency converter 24.

For example, the frequency converter 24 up-converts the electric signal M2a received from the amplifier 23A to generate an RF signal, and outputs the generated RF signal to the antenna 161. Alternatively, the frequency converter 24 down-converts the electric signal M2a received from the amplifier 23A to generate a baseband signal, and transmits the generated baseband signal to a device outside the slave station device 202.

The optical demodulator 42B receives the optical signal of the wavelength λ2 from the separator 41, generates an electric signal M2b having a level according to the intensity of the received optical signal, and outputs the electric signal M2b to the amplifier 23B.

The amplifier 23B receives the electric signal M2b from the separator 41, amplifies the received electric signal M2b, and outputs the amplified electric signal M2b to the 8B/10B demodulator 25.

The 8B/10B demodulator 25 8B/10B-demodulates the electric signal M2b received from the amplifier 23B, and outputs the resultant signal to the deframer 27. That is, the 8B/10B demodulator 25 converts a 10-bit electric signal M2b received from the amplifier 23B into an 8-bit electric signal M2b, and outputs the resultant signal to the deframer 27.

The deframer 27 acquires plural pieces of control information from the digital signal included in the optical signal received by the separator 41. More specifically, the deframer 27 receives the electric signal M2b from the 8B/10B demodulator 25, and acquires the Ethernet frame from the received electric signal M2b. If the destination MAC address included in the acquired Ethernet frame matches the MAC address of the slave station device 202, the deframer 27 acquires the plural pieces of control information from the payload of the Ethernet frame, and outputs the acquired plural pieces of control information to the control information processing unit 28.

The control information processing unit 28 receives the plural pieces of control information from the deframer 27, and processes the received control information. For example, the control information processing unit 28 receives beamforming information as an example of the control information, and performs a process of controlling the direction of a beam outputted from the antenna 161, according to the received beamforming information.

The above embodiments are merely illustrative in all aspects and should not be recognized as being restrictive. The scope of the present disclosure is defined by the scope of the claims rather than by the description above, and is intended to include meaning equivalent to the scope of the claims and all modifications within the scope.

The processes (functions) of the above-described embodiments may be realized by processing circuitry including one or more processors. In addition to the one or more processors, the processing circuitry may include an integrated circuit or the like in which one or more memories, various analog circuits, and various digital circuits are combined. The one or more memories have, stored therein, programs (instructions) that cause the one or more processors to execute the processes. The one or more processors may execute the processes according to the program read out from the one or more memories, or may execute the processes according to a logic circuit designed in advance to execute the processes. The above processors may include a CPU (Central Processing Unit), a GPU (Graphics Processing Unit), a DSP (Digital Signal Processor), an FPGA (Field Programmable Gate Array), an ASIC (Application Specific Integrated Circuit), etc., which are compatible with computer control. The physically separated processors may execute the processes in cooperation with each other. For example, the processors installed in physically separated computers may execute the processes in cooperation with each other through a network such as a LAN (Local Area Network), a WAN (Wide Area Network), or the Internet. The program may be installed in the memory from an external server device or the like through the network. Alternatively, the program may be distributed in a state of being stored in a recording medium such as a CD-ROM (Compact Disc Read Only Memory), a DVD-ROM (Digital Versatile Disk Read Only Memory), or a semiconductor memory, and may be installed in the memory from the recording medium.

The above description includes the features in the additional notes below.

### [Additional Note 1]

An optical communication system including:
a master station device; and
a slave station device, wherein
the master station device generates a digital signal including one frame in which plural pieces of control information are stored, and transmits an optical signal including the generated digital signal and an analog main signal, to the slave station device via an optical fiber,
the slave station device acquires at least one piece of control information out of the plural pieces of control information, from the digital signal included in the optical signal received from the master station device via the optical fiber, and
the master station device generates the digital signal that includes the frame including destination information of the slave station device.

### REFERENCE SIGNS LIST

11 signal reception unit
12 frequency converter
13 control information output unit
14 framer
15 8B/10B modulator
16 LPF
17 multiplexer
18 optical modulator
21 optical demodulator
22 separator
23A, 23B amplifier
24 frequency converter
25 8B/10B demodulator
26 LPF
27 deframer
28 control information processing unit
31A, 31B optical modulator
32 multiplexer
41 separator
42A, 42B optical demodulator
101,102 master station device
161 antenna
201,202 slave station device
191 optical fiber
301, 302 optical communication system

1. An optical communication system comprising:
a master station device; and
a slave station device, wherein
the master station device generates a digital signal including one frame in which plural pieces of control information are stored, and transmits an optical signal including the generated digital signal and an analog main signal, to the slave station device via an optical fiber, and
the slave station device acquires at least one piece of control information out of the plural pieces of control information, from the digital signal included in the optical signal received from the master station device via the optical fiber.

2. The optical communication system according to claim 1, wherein
the master station device generates the optical signal based on an electric signal in which the digital signal and the main signal are frequency-multiplexed, and transmits the generated optical signal to the slave station device via the optical fiber.

3. The optical communication system according to claim 2, wherein
the master station device frequency-multiplexes a signal passing through a first low-pass filter that receives the digital signal, with the main signal.

4. The optical communication system according to claim 2,
wherein the slave station device generates an electric signal based on the optical signal received from the master station device via the optical fiber, separates the digital signal from the electric signal by using a filter, and acquires the control information from a signal passing through a second low-pass filter that receives the separated digital signal.

5. The optical communication system according to claim 1, wherein
the master station device generates a first optical signal based on the digital signal, generates the optical signal by wavelength-multiplexing the generated first optical signal with a second optical signal based on the main signal, and transmits the generated optical signal to the slave station device via the optical fiber.

6. A master station device, comprising:
a generation unit configured to generate a digital signal including one frame in which plural pieces of control information are stored; and
a transmission unit configured to transmit an optical signal including the digital signal generated by the generation unit, and an analog main signal, to another device via an optical fiber.

7. A slave station device, comprising:
a reception unit configured to receive an optical signal that includes a digital signal including one frame in which plural pieces of control information are stored, and an analog main signal, from another device via an optical fiber; and
an acquisition unit configured to acquire at least one control information out of the plural pieces of control information, from the digital signal included in the optical signal received by the reception unit.

8. An optical communication method in an optical communication system including a master station device and a slave station device, the method comprising:
by the master station device, generating a digital signal including one frame in which plural pieces of control information are stored, and transmitting an optical signal including the generated digital signal and an analog main signal, to the slave station device via an optical fiber; and
by the slave station device, acquiring at least one piece of control information out of the plural pieces of control information, from the digital signal included in the optical signal received from the master station device via the optical fiber.
